(19) United States
(12) Patent Application Publication
(10) Pub. No.: US 2007/0256615 A1
(43) Pub. Date: Nov. 8, 2007

(54) System and method for unattended access to safe deposit boxes

(76) Inventors: David Delgrosso, Naperville, IL (US); Fraser Orr, Naperville, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/654,493

(22) Filed: Jan. 17, 2007

Related U.S. Application Data
(60) Provisional application No. 60/759,443, filed on Jan. 17, 2006.

(51) Int. Cl. E05G 1/10; E05G 1/08

(52) U.S. Cl. 109/38; 109/23; 109/56

(57) ABSTRACT

A safe deposit box access system is provided. A user provides biometric credential information such as a fingerprint scan to gain access to a vault storing a plurality of safe deposit boxes. Each of the safe deposit boxes is equipped with a sensor for detecting movement and motion. The sensor comprises a transmitter for transmitting a unique identification number corresponding to that safe deposit box to a receiver. The receiver is coupled to a computer, which compares the identification number of the moved or opened safe deposit box to the stored profile of the user who gained biometric access to the vault. If the moved or opened safe deposit box does not correspond to the safe deposit box rented by the user who gained biometric access, an alarm is triggered.

### CROSS-REFERENCE TO RELATED APPLICATIONS

This present application claims the benefit of Provisional Application No. 60/759,443 filed Jan. 17, 2006, the contents of which are incorporated herein by reference.

### FEDERALLY SPONSORED RESEARCH OR DEVELOPMENT

N/A

### TECHNICAL FIELD

The invention generally relates to a system and method for facilitating unattended access to safe deposit boxes, and more particularly, to a system and method for allowing an unattended user access only to the user's safe deposit box.

### BACKGROUND OF THE INVENTION

Banks and other similar financial institutions are concerned with allowing customers and other people unattended into a vault of safe deposit boxes. Specifically, there is a concern that a thief will be able to gain unauthorized access to a safe deposit box, perhaps by picking the lock. Consequently, most banks require that a member of the bank staff be present when opening a safe deposit box. In many instances that requirement is often enforced by having dual locks on the box, one opened by the renter of the box and the other opened with a key held by the bank.

Providing bank staff members to manage the safe deposit boxes is expensive and time consuming. It also increases the time needed by the customer to gain access to the box, because the customer must first find a staff member, who must then verify the customer's identity, and find the appropriate key.

Additionally, there is a risk associated with that process in that not all staff members are honest. It is possible for the potential thief to simply bribe a staff member to provide the bank key and thereby gain access.

Due to the nature of safe deposit boxes and the privacy typically accorded their use, video surveillance is usually not an acceptable alternative solution to the security problem. Further, since the banks typically do not know what is stored inside the boxes, there is an extremely high liability associated with theft from the boxes.

An emerging solution is the use of biometrics to control access to a gate associated with a bank's vault of safe deposit boxes. The “day gate”, as it is known, is a physical barrier that prevents access to the vault in which the safe deposit boxes are kept. During the night, the vault door is closed to prevent access entirely.

The biometric gate is equipped with a biometric reader, which registers biometric information such as a handprint or fingerprint for each person renting a safe deposit box. That information is stored in a database. The boxes have only one lock, and the renter has the key to that lock. When the renter desires access to the box, the renter provides a fingerprint scan to open the day gate, and then uses her key to unlock the box.

However, once the customer gains entry to the vault through the day gate, there is no way to ensure that the customer will access the appropriate box. Thus, a thief with lock-picking skills, or a thief with a stolen key, can rent a box at a bank, gain legitimate biometric access to the day gate, enter the vault unattended, and steal contents from another box unobstructed by the bank's staff, without setting off any alarm. The day gate access system is therefore convenient, but still has a great cost in terms of the security and liability to the bank.

Another recently emerging alternative is an electronic safe deposit lock, wherein the mechanical locks on the safe deposit boxes are replaced with electronic locks. These electronic locks are opened with a computerized key, which is encoded with a unique electronic signature. The key provides the signature to the box electronically. Upon recognition of the electronic signature the key is turned to open the physical lock device.

An electronic lock system can be combined with a biometric day gate access system. That solution provides biometric access to the day gate and, the system's electronic key signature only provides access to the exact box corresponding to that signature. Moreover, electronic locks are highly difficult to pick. However, a system combining the biometric day gate and an electronic lock system suffers from a number of disadvantages. First, the electronic locks are very expensive, as is retrofitting a bank vault of deposit boxes with such locks. Second, because an unattended thief can gain access to a vault (by legitimately renting another box) the possibility remains that a thief could still pick the lock, or bring equipment to drill through a hole in another box.

The present invention is provided to solve the problems discussed above and other problems, and to provide advantages and aspects not provided by prior access systems of this type. A full discussion of the features and advantages of the present invention is deferred to the following detailed description, which proceeds with reference to the accompanying drawings.

### SUMMARY OF THE INVENTION

An unattended safe deposit box access system is provided. The renter of the safe deposit box establishes a profile on a bank's computer system, and that profile is stored in a database. The profile includes biometric credential information identifying the user, such as a fingerprint.

The user gains access to the bank's safe deposit box vault by providing biometric credential information, e.g., via a fingerprint scanning device. The vault door is opened upon a match being found in the database between the scanned fingerprint and the profile record for the renter stored in the database. Inside the vault, the user uses a standard safe deposit box key to open the rented safe deposit box.

Each safe deposit box is equipped with a sensor, which senses movement or motion of the safe deposit box. Upon sensing such movement or motion, the sensor transmits an identification number uniquely corresponding to that safe deposit box to a receiver. The receiver is coupled to a computer, which compares the identification number of the opened or moved safe deposit box to the profile record of the user who biometrically gained access to the vault.

If the identification number of the safe deposit box that was opened or moved does not correspond to the safe deposit box rented by the user who gained biometric access to the safe deposit box vault, an alarm is triggered.

In accordance with one embodiment of the invention, a biometric access security system for providing a safe deposit box renter with unattended access to a rented safe deposit box located in a vault having a vault gate is provided. The system comprises a bank computer having a renter registration database for storing registered renter identification information, associated renter biometric information, and associated safe deposit box information for a plurality of renters. The system also includes a biometric gate sensor proximate the vault gate for receiving renter biometric information for gaining access to the vault through the vault gate, wherein the renter biometric information received from the biometric gate sensor is transmitted to the bank computer and compared to the stored biometric information for determining whether to unlock the vault gate. A safe deposit sensor in communication with the bank computer is positioned proximate at least one of the safe deposit boxes (e.g., on the door of the safe deposit box) for sensing an action associated with the at least one of the safe deposit boxes. The bank computer is configured to compare the safe deposit box associated with the action to the safe deposit box associated with the renter biometric information received from the biometric gate sensor and determine if the renter is accessing the renter's rented safe deposit box.

The system further comprises an automatic lock proximate the vault gate for opening and locking the vault gate. The automatic lock is in communication with the bank computer which is configured to send a signal to open the automatic lock when the received biometric information and the stored biometric information match. The bank computer can be configured to store a first time when the biometric gate sensor senses the renter biometric information, a second time when the action takes place, and to compare the first time to the second time and determine whether the comparison is less than a predetermined time period. The bank computer can trigger an alarm when the comparison is less than a predetermined time period.

In accordance with another aspect of the invention, a system for providing unattended access to a user's rented safe deposit box in a vault having a plurality of safe deposit boxes comprises a biometric device for providing the user access to a vault gate; and, a sensor connected to the user's rented safe deposit box. The sensor is configured to receive a signal from a bank computer indicating whether the user is authorized to have access to the safe deposit box.

The system can further comprise a shield covering a user keyhole of the safe deposit box. In this instance, the signal from the bank computer permits the shield to move to allow access to the user keyhole. The shield can include a flange and a solenoid configured to limit movement of the flange absent receipt of the signal.

The system further comprises a transmitter connected to the user's rented safe deposit box. The transmitter is configured to transmit a signal to the bank computer upon an attempt to gain access to the safe deposit box. In one embodiment, a motion sensor can be connected to the user's rented safe deposit box. The motion sensor is configured to sense a user's attempt to open the rented safe deposit box. Other sensors, such as a trembler switch can also be utilized to sense an attempt to access the safe deposit box.

In accordance with yet another embodiment of the invention, a system for providing unattended access to a safe deposit box in a vault containing a plurality of safe deposit boxes is provided. The system includes a vault containing a plurality of safe deposit boxes. Each of the safe deposit boxes in the vault includes a lock with a user keyhole. A user renting a safe deposit box is provided with the key for that box. The system also includes a plurality of sensors. Each sensor is connected to one of the plurality of safe deposit boxes and includes a transmitter. A remote computer containing information pertaining to authorized users of each of the plurality of safe deposit boxes is also provided. The computer is configured to communicate with the sensor.

The system further comprises a gate for providing access to the vault, and a biometric device associated with the gate. The biometric device is configured to receive biometric information of a user and forward the information to the computer. The computer compares the biometric information with data stored in a memory associated with the computer and provides an indication of whether the user is authorized to have access to a safe deposit box in the vault. The computer can also send a signal to a safe deposit box associated with the user to allow the user to access the safe deposit box.

Each sensor can be configured to send a signal to the computer upon sensed movement of the safe deposit box. The computer can then compare the identity of any safe deposit box the computer receives a signal of movement from with the safe deposit box associated with the user. The computer can activate an alarm if the safe deposit box sending a signal of movement does not match the safe deposit box associated with the user.

In one embodiment of this system, each safe deposit box includes a cover device over the user keyhole. The cover device can be configured to be movable to provide access to the user keyhole upon receipt of a signal from the computer.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of a safe deposit box access system configured in accordance with the principles of the present invention.

FIG. 2 is a diagram of a safe deposit box and sensor configured in accordance with the principles of the present invention.

FIG. 3 is an illustration of a safe deposit box configured in accordance with the principles known in the prior art.

FIG. 4 is an illustration of an exterior access mechanism to a safe deposit box configured in accordance with the principles of the present invention.

FIG. 5 is an illustration of a safe deposit lock mechanism, in a first state, that is configured in accordance with the principles of the present invention.

FIG. 6 is an illustration of a safe deposit lock mechanism, in a second state, that is configured in accordance with the principles of the present invention.

FIG. 7 is an illustration of a safe deposit lock mechanism, in a third state, that is configured in accordance with the principles of the present invention.

FIG. 8 is an illustration of a safe deposit lock mechanism, in a fourth state, that is configured in accordance with the principles of the present invention.

FIG. 9 is an illustration of a safe deposit lock mechanism, in a fifth state, that is configured in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present invention provides a system and method for providing access to safe deposit boxes without the need for assistance from bank personnel. The system also addresses the security risks and retrofitting disadvantages associated with the prior art.

A biometric day gate system 14 is provided for use with the present system. To utilize the biometric day gate system 14, a user or renter of a safe deposit box registers her fingerprint (or other biometric information or credentials) with the bank. That fingerprint is stored in a database. When the renter desires access to her safe deposit box, she provides her fingerprint or other biometric credential, and thereby gains access to the vault 16 containing the safe deposition boxes 18 via the day gate 14.

Inside the vault 16, the renter uses a standard safe deposit box key to open her rented box 18. Attached to the box 18 is a sensor 20. The sensor 20 may be attached either on the outside of the box 18, using industrial adhesive, to the inside of the box or inside the inner wall of the box. The sensor 18 can comprises a trembler switch or similar electronic device to detect motion. The sensor 18 further comprises a wireless transmitter 26 for transmitting a unique identification number associated with that safe deposit box 18.

When the safe deposit box 18 is moved or opened, the sensor 20 transmits the identification number associated with that safe deposit box 18 wirelessly to a receiver 28, thereby indicating to the receiver 18 which box 18 has been opened. The receiver 28 is coupled to a computer system 36 having a database 38 for enabling this function. The computer 36 is configured to compare the received identification number of the box to the biometric information presented to the day gate 14 by the user. If the box 18 that has been opened or moved is not the box 18 corresponding to the person who entered the day gate 14, an alarm is triggered. If, however, the box 18 that has been opened is the box corresponding to the person who entered the day gate 14, the alarm is not triggered.

The system is further optimized to configure where the alarm is triggered. The alarm can be triggered within the bank, the bank lobby, and the vault or any combination thereof. Likewise, the alarm can be a silent alarm communicated to a law enforcement agency. The triggering of the alarm can further be coupled with the closing of the day gate.

The sensor device 20 comprises a switch to detect when the box has been opened or moved. Various switching technologies can be used to ensure varying degrees of security to prevent bypassing the switch technology. The sensor device 20 further comprises a transmitter 26, for transmitting the identification number of the box to the receiver 28. The sensor further comprises a power cell, holding charge in a capacitor 32. In a preferred embodiment, the sensor is a solar cell device, equipped with a capacitor 32 so as not to lose power when the lights are turned off. Alternatively, the power source or supply 34 is a lithium ion battery, or the like.

In a preferred embodiment, the sensor 20 is attached to the exterior of the safe deposit box with industrial adhesive, and thereby offers an inexpensive and fast option for the retrofitting of existing safe deposit boxes 18 within a bank. The sensor 20 can be programmed by being placed in communication with the computer 36. The computer 36 transmits the identification number to the sensor 20, and preferably, encryption data such that the wireless information transmitted by the sensor 20 is encrypted, as is preferably, the data stored within the sensor's programmable logic controller 22 and memory 24.

In the event that a thief tries simply to pull the sensor 20 from the box 18, such action would be sufficient to trigger the transmittal of the identification number to the receiver 28, and thereby trigger the alarm. Likewise, a vibration, such as drilling through the side of the box 18, would also be sufficient to trigger the sensor switch, and thereby transmit the identification number to the receiver 28, and thereby trigger the alarm.

The present invention eliminates the need for bank personnel to enter the vault 16, thus reducing the cost of the status quo prior art system. The sensor 20 is simple to retrofit to existing safe deposit boxes 18, provides a simple monitoring mechanism for bank personnel. It also ensures the safe of the contents of the boxes 18.

In one embodiment of the present invention, a cover device 48 is attached to a safe deposit box 18, so that the cover device 48 covers the lock hole or lock holes 44,46 on the box 18. The cover device 48 is attached to circuitry that indicates movement of the cover device 48. Upon movement of the cover device 48, circuitry is activated that listens for a broadcast signal to be transmitted. A user uses a safe deposit box key to open the lock that rested under the now-open cover device. When the key is inserted into the lock, a unique identification code corresponding to the safe deposit box is transmitted. When the receiver receives that identification code, the circuitry stops listening for the unique identification code to be transmitted. If the receiver does not receive the transmission of the unique identification code, an alarm is activated.

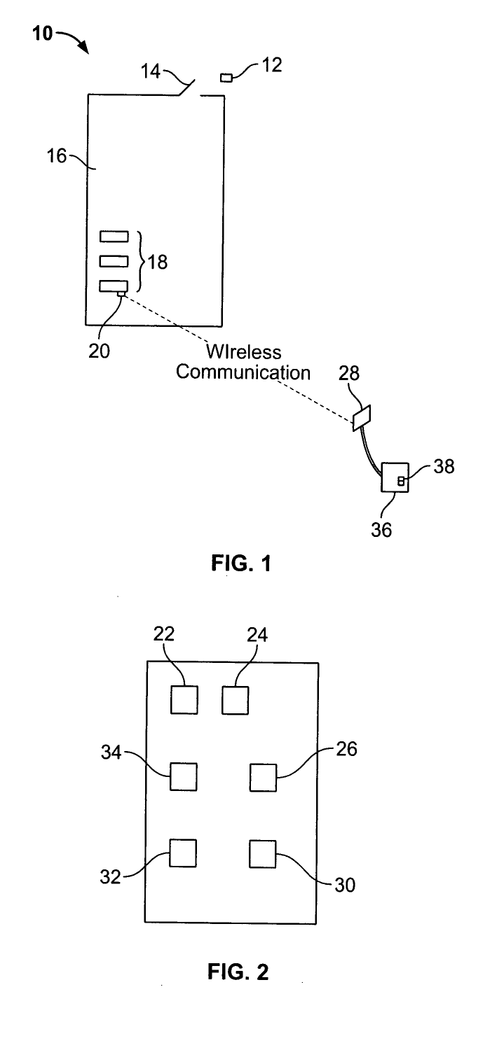

Referring initially to FIG. 1, an overview of a safe deposit box access system 10 is illustrated. To implement, a user enters biometric information (such as a fingerprint) into a biometric input device 12 (such as a fingerprint scanner). The biometric information can also be a retinal scan, a blood scan, a DNA scan or another type of scan for unique biometric information associated with the user. The user's biometric information is then compared to biometric information stored in the database. If the user is determined to have a valid purpose for entering the bank (e.g., is a customer of the bank's with a valid and current safe deposit box), a signal is transmitted to a biometric gate 14, which opens. If the user's biometric information does not correspond to any valid user's biometric information stored in the database, the biometric gate 14 is not opened and the user does not gain access to the vault 16.

Inside the bank vault 16, the user has access to safe deposit boxes 18 stored within the vault 16. Each of the safe deposits boxes 18 is locked. Additionally, each safe deposit box 18 is provided with a sensor 20.

Referring also to FIG. 2, a safe deposit box 18 configured in accordance with the present invention is illustrated. The safe deposit box 18 preferably has a programmable logic controller 22, such as a microprocessor, and a memory 24, such as a random-access-memory or read-only memory. The safe deposit box 18 also preferably includes a transmitter 26, which places the safe deposit box in communication with a wireless receiver 28 located elsewhere in the bank or the vault 16. Preferably, the transmitter 26 is a wireless transmitter. The safe deposit box 18 also preferably includes a trembler switch 30, which senses motion. The trembler switch 30 can also be comprised of a motion detection circuit, a magnetic circuit, or a heat sensory circuit. In one embodiment, the components illustrated in FIG. 2 are built into the safe deposit box itself. In another embodiment, the components illustrated in FIG. 2 are comprised in a housing, which is attached to the safe deposit box 18.

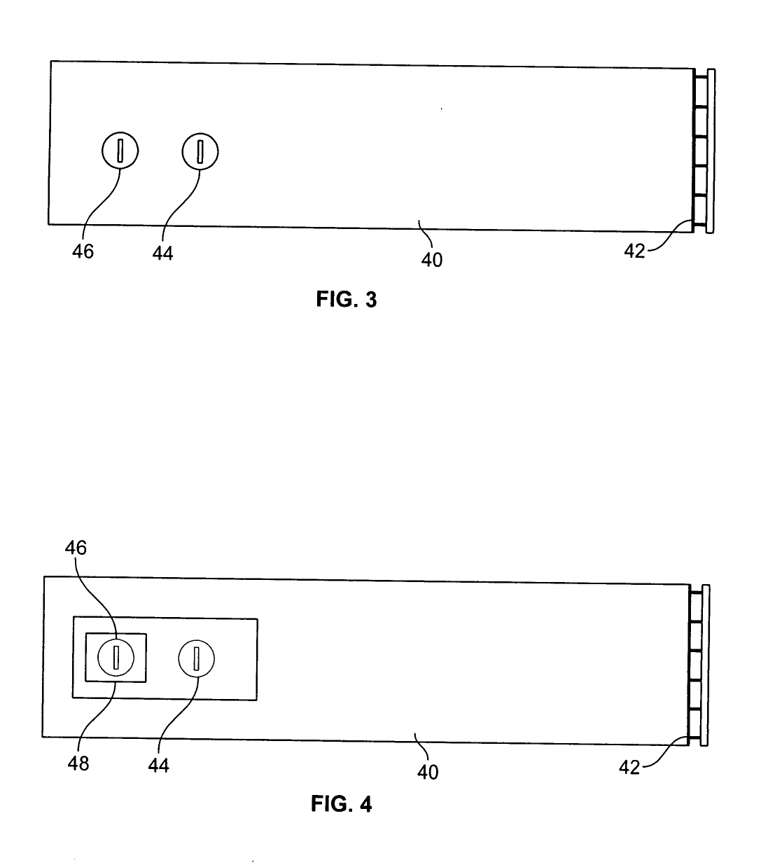

Referring now to FIG. 3, there is illustrated the exterior of a safe deposit box 18 configured in accordance with the principles of the prior art. As illustrated, the standard safe deposit box 18 configuration comprises a locked door 40, access to which is permitted only to a keyholder. The door 40 is attached by a hinge 42 to the safe deposit box 18, such that access to the interior of the box 18 is accorded only upon successful opening of the door 40. As illustrated, a safe deposit box 18 typically has two keyholes 44, 46. The first keyhole 44 is configured to receive a bank key (i.e., a bank lock), and the second keyhole 46 is configured to receive a user key (i.e., a customer lock). The user key is retained by the user, whereas the bank key is retained by the bank. The door 40 of the safe deposit box 18 is configured to open only upon the successful entry of both keys into the keyholes 44, 46 of the box 18. In accordance with the prior art method for opening the box 18, bank personnel must enter the vault 16 with the bank key and must be present with the user.

Referring to FIG. 4, there is illustrated the exterior of a safe deposit box 18 configured in accordance with the principles of the present invention. Only the user keyhole 46 is required. In one embodiment and as illustrated, the user keyhole 46 is covered with a covering device 48, which will be described in detail herein. Further illustrated in FIG. 4 is a method of retrofitting existing safe deposit boxes 18 with the present invention. To retrofit an existing safe deposit box 18 having a bank keyhole, the bank keyhole 44 is left in the “open” position, so as to permit access to the box 18 upon the successful entry of only the user key. Preferably, the bank keyhole 44 is then hidden or sealed so as to be inaccessible to the user.

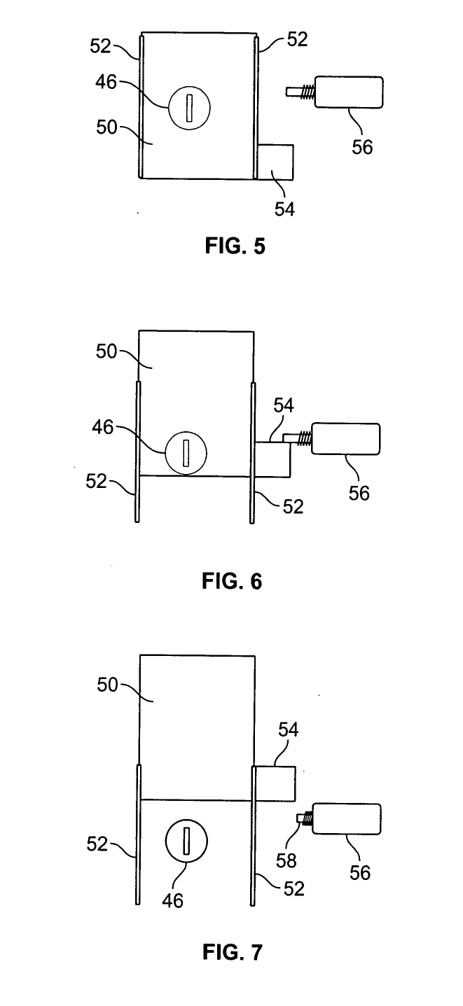

Referring to FIG. 5, the covering device 48 of the present invention, in a first state, is illustrated. The covering device 48 comprises a shield 50, which covers the user keyhole 46 on the exterior of the safe deposit box 18. The shield 50 is positioned within slide rails 52, so as to be lifted upwards or downwards. The shield 50 moves within the slide rails 52, so that when the shield 50 is moved, access to the user keyhole 46 is provided. In the embodiment illustrated, the shield 50 is configured to slide upwards within the slide rails 52 from a closed position. The shield 50 has a flange 54 which extends outward from the shield 50. When the shield 50 is moved, the flange 50 is thereby also moved, so as to be placed in contact with a solenoid 56. It will be understood that the solenoid 56 can be a trembler switch, an electrical switch, a mechanical switch, a magnetic switch or any other switch capable of sensing the movement of the shield 50.

Referring to FIG. 6, the covering device 48 of the present invention, in a second state, is illustrated. In a preferred embodiment and as illustrated, the solenoid 56 prevents access to the keyhole 46 when the shield 50 is moved. In other words, when the user moves the shield 50 upward so as to gain access to the user keyhole 46, a plunger or armature 58 of the solenoid 56 physically blocks the movement of the flange 54, and thereby physically blocks the movement of the shield 50. It will be understood that the blockage of the flange 54 can also be performed magnetically or electronically, or through a combination thereof. When the flange 54 is placed in contact with the armature 58 of the solenoid 56, a circuit is activated within the covering device 48. The circuit listens for a signal that identifies the user of the safe deposit box 18. It will be understood that “listening” for such a signal constitutes a polling for a transmission performed by the circuitry of the present invention.

The signal can comprise a simple flag such as a yes/no flag, and can also comprise information identifying the identify of the user, so long as the purpose of the signal is to indicate to the circuitry at the safe deposit box 18 that the user attempting to gain access to the safe deposit box 18 is indeed authorized to have such access. The signal is preferably transmitted to the circuitry at the box 18 by a control system (e.g., the computer 36) located elsewhere in the bank or the vault 16. In a preferred embodiment and as illustrated in FIG. 2, the signal is generated and transmitted to the safe deposit box 18 based on a biometric recognition of the user as a user that has authority to gain access to the box 18. Alternatively, the signal may be generated by bank personnel, and may be based on visual or other identification of the user as a user that has authority to gain access to the box. In other words, the purpose of the signal is to indicate to the safe deposit box 18 whether the user attempting to gain access to the safe deposit box 18 is in fact authorized to do so. In one embodiment, the signal is encrypted and the circuitry located at the safe deposit box includes a decryption key and decryption routine to decrypt and understand the signal.

Referring to FIG. 7, the covering device 48 of the present invention, in a third state, is illustrated. When the signal is received by the circuitry of the device 48, indicating that the user attempting to gain access to the safe deposit box 18 is authorized to have such access, the solenoid 56 is activated by the circuitry causing the armature 58 to retract. This permits the flange 54 to move upward within the slide rails of the covering device. The movement of the flange 54 in turn allows movement of the shield 50, permitting the user to have access to the user keyhole. It will be understood that the solenoid 56 can be a latching solenoid, so that electrical power to activate (i.e., retract the armature 58 of the solenoid 56 from its position in contact with the flange 54) need only be supplied for a brief period of time, such as one or two seconds. It will be further understood that various options exist for providing electrical power to the cover device 48 and its attendant circuitry. Those options include a battery supply such as a lithium ion or nickel cadmium battery, an induced current that induces a current in an antenna or other transmitter of the device, or a solar cell located to receive and store solar energy. If a signal is received at the safe deposit box 18 indicating that the user attempting to gain access to the safe deposit box 18 is not authorized to have such access, an alarm at the bank or vault 16 can be triggered, indicating a potential breach of security. Alternatively, the circuitry includes a timer, such that if a positive identification signal is not received within a predetermined period of time, the security alarm is tripped and the bank is alerted to a potential breach of security. In that alternative embodiment, it will be understood that a negative identification signal need not be generated by the remote control system; only the absence of a positive signal is required for the identity of the putative user to be called into question. It will be further understood that in this embodiment, in the absence of electrical power to the solenoid, the shield will not be able to be moved even if a positive identification signal is transmitted by the remote control system. Thus, when the present invention is not powered, or is receiving insufficient electrical power, access to the safe deposit box will not be inadvertently granted to the putative user of the box 18.

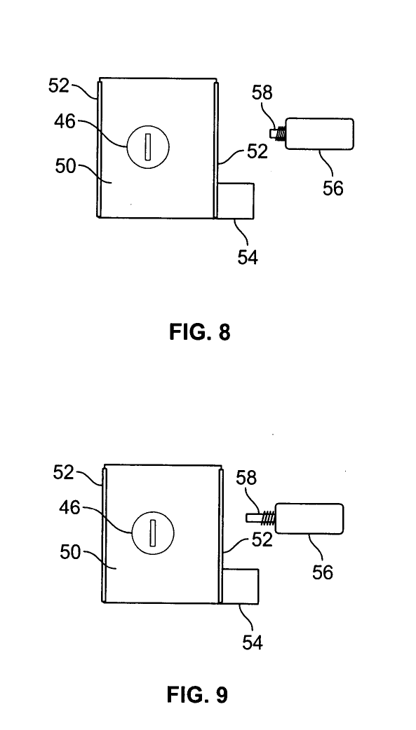

Referring to FIG. 8, the covering device 48 of the present invention, in a fourth state, is illustrated. When the user removes the key from the user keyhole 46, the shield 50 slides back into place along the slide rails 52 so as to once again cover the user keyhole 46. When the shield 50 is returned to its original position—covering the user keyhole 46—the flange 54 does not come into contact with the armature 58 of the solenoid 56, because the armature 58 of the solenoid 58 remains in the open (i.e., retracted) position.

Referring to FIG. 9, the covering device 48 of the present invention, in a fifth state, is illustrated. The circuitry at the safe deposit box 18 activates the solenoid 56, causing the armature 58 to move into a closed (i.e., extended) position, thereby prohibiting movement of the flange 54 past the solenoid 56. It will be understood that a variety of configurations can be employed to determine when to return the solenoid 56 to the closed position. In one embodiment, the circuitry includes a timer, such that the solenoid 56 is returned to the closed position after the expiration of a predetermined period of time. In another embodiment, the solenoid 56 is activated upon receipt of a signal from the remote security system. That signal can likewise be generated based on a timer, or based upon a signal or other determination that the user of the safe deposit box 18 has finished using the box 18 and/or has existed the bank and/or vault 16.

It will be understood that variations exist on the principles of the present invention without departing from the concepts thereof. In one such variation, the covering device 48 of the present invention is activated upon the entry of the user into vault 16. In that embodiment, when the user provides biometric information into the biometric scanner 12, the user thereby gains access to the vault 16. At that time, the remote security system transmits the user identification signal to the appropriate safe deposit box 18. The solenoid 56 on that safe deposit box 18 is activated in response to that signal, so that the shield 50 and flange 54 can be moved past the solenoid 56 even before the user arrives at the box. The solenoid 56 can remain in the open position for a predetermined period of time, such as two minutes.

In another embodiment, a motion sensor circuit is placed within or underneath the safe deposit box 18. The user gains access to the user keyhole 46 without prohibition by a cover device 48 or similar device, but when the door to the safe deposit box 18 is opened, or the box is moved, the circuitry at the box 18 is activated to poll for the user identification signal. If the signal is not received within a predetermined period of time (e.g., one or two seconds), an alarm can be triggered to indicate a potential breach of security. Such motion sensor circuitry can be comprised in a device that can be attached to the surface of the safe deposit box without requiring a modification of existing boxes 18 themselves.

In another embodiment, a motion sensor circuit is placed at the exterior of the box 18 and is activated upon intimate user contact with the exterior of the box 18. Such intimate contact could be triggered, for example, when the user attempts to insert the user key into the user keyhole 46. A laser beam, heat sensor, light sensor, motion detector, solenoid or trembler switch can be used to indicate that the user has either approached the box or has inserted the user key into the user keyhole 46. Upon such an event, the circuitry at the box 1 8can be activated to poll for the user identification signal.

The present invention also provides a number of alternate mechanisms for the bank key corresponding to the bank keyhole 44 at the safe deposit box 18. One such alternative is to provide unattended access to the safe deposit box 18 by simply lending the bank key to the user. Then, when the user attempts to access the box 18, the same user identification principles employed as described herein, and the user has the bank key as well, but physical attendance by bank personnel is not required. Another alternative is to open all of the bank keyholes in the vault, for all of the safe deposit boxes, and then leave those locks in the open position. The locks can then be hidden or otherwise covered, so as to both avoid confusion to the user and avoid the necessity of physical presence of bank personnel. Another alternative is to physically adjust the existing bank keyhole to be placed in the open position while the user keyhole is placed in the open position, such that when the user opens the user lock, the user thereby simultaneously opens the bank lock with the same key. Another alternative is to house the circuitry and attendant devices of the present invention within a safe deposit box that has no bank keyhole at all.

While the specific embodiments have been illustrated and described, numerous modifications come to mind without significantly departing from the spirit of the invention, and the scope of protection is only limited by the scope of the accompanying Claims.

What is claimed is:

1. A biometric access security system for providing a safe deposit box renter with unattended access to a rented safe deposit box located in a vault having a vault gate, comprising:
a bank computer having a renter registration database for storing registered renter identification information, associated renter biometric information, and associated safe deposit box information for a plurality of renters;
a biometric gate sensor proximate the vault gate for receiving renter biometric information for gaining access to the vault through the vault gate, wherein the renter biometric information received from the biometric gate sensor is transmitted to the bank computer and compared to the stored biometric information for determining whether to unlock the vault gate;
a safe deposit sensor in communication with the bank computer positioned proximate at least one of the safe deposit boxes for sensing an action associated with the at least one of the safe deposit boxes, wherein the bank computer is configured to compare the safe deposit box associated with the action to the safe deposit box associated with the renter biometric information received from the biometric gate sensor and determine if the renter is accessing the renter's rented safe deposit box.

2. The system of claim 1 further comprising an automatic lock proximate the vault gate for opening and locking the vault gate, wherein the automatic lock is in communication with the bank computer, wherein the bank computer is configured to send a signal to open the automatic lock when the received biometric information and the stored biometric information match.

3. The system of claim 1 wherein the bank computer is configured to store a first time when the biometric gate sensor senses the renter biometric information, a second time when the action takes place, and to compare the first time to the second time and determine whether the comparison is less than a predetermined time period.

4. The system of claim 3, wherein bank computer is configured to trigger an alarm when the comparison is less than a predetermined time period.

5. The system of claim 1 wherein the safe deposit sensor is mounted on a face of a door of the at least one of the plurality of safe deposit boxes, for sensing an action associated with the at least one of the safe deposit boxes.

6. A system for providing unattended access to a user's rented safe deposit box in a vault having a plurality of safe deposit boxes comprising:
a biometric device for providing the user access to a vault gate; and, a sensor connected to the user's rented safe deposit box, the sensor configured to receive a signal from a bank computer indicating whether the user is authorized to the safe deposit box.

7. The system of claim 6 further comprising a shield covering a user keyhole of the safe deposit box.

8. The system of claim 7 wherein the signal from the bank computer permits the shield to move to allow access to the user keyhole.

9. The system of claim 8 wherein the shield includes a flange.

10. The system of claim 9 further comprising a solenoid configured to limit movement of the flange absent receipt of the signal.

11. The system of claim 6 further comprising a transmitter connected to the user's rented safe deposit box wherein the transmitter is configured to transmit a signal to the bank computer upon an attempt to gain access to the safe deposit box.

12. The system of claim 11 further comprising a motion sensor connected to the user's rented safe deposit box configured to sense a user's attempt to open the rented safe deposit box.

13. The system of claim 11 further comprising a trembler switch connected to the user's rented safe deposit box configured to sense a user's attempt to open the rented safe deposit box.

14. A system for providing unattended access to a safe deposit box in a vault containing a plurality of safe deposit boxes comprising
a vault containing a plurality of safe deposit boxes, each of the safe deposit boxes having a lock with a user keyhole,
a plurality of sensors, each sensor connected to one of the plurality of safe deposit boxes, each sensor having a transmitter; and
a remote computer containing information pertaining to authorized users of each of the plurality of safe deposit boxes, the computer configured to communicate with the sensor.

15. The system of claim 14 further comprising:
a gate for providing access to the vault;
a biometric device associated with the gate, the biometric device configured to receive biometric information of a user and forward the information to the computer, wherein the computer is configured to compare the biometric information with data stored in a memory associated with the computer and provide an indication of whether the user is authorized to have access to a safe deposit box in the vault.

16. The system of claim 15 further comprising the computer sending a signal to a safe deposit box associated with the user to allow the user to access the safe deposit box.

17. The system of claim 15 wherein each sensor is configured to send a signal to the computer upon sensed movement of the safe deposit box.

18. The system of claim 17 wherein the computer is configured to compare the identity of any safe deposit box the computer receives a signal of movement from with the safe deposit box associated with the user and to activate an alarm if the safe deposit box sending a signal of movement does not match the safe deposit box associated with the user.

19. The system of claim 15 wherein each safe deposit box includes a cover device over the user keyhole.

20. The system of claim 19 wherein the cover device is movable to provide access to the user keyhole upon receipt of a signal from the computer.
